(19) United States
(12) Patent Application Publication
(10) Pub. No.: US 2005/0141718 A1
(43) Pub. Date: Jun. 30, 2005

(54) Method of transmitting and receiving message using encryption/decryption key

(76) Inventors: Joon Suk Yu, Daejeon-city (KR); Jae Hoon Nah, Daejeon-city (KR); Taek Young Nam, Daejeon-city (KR); Sung Won Sohn, Daejeon-city (KR); Chee Hang Park, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/860,970

(22) Filed: Jun. 3, 2004

(30) Foreign Application Priority Data
Dec. 26, 2003 (KR) 2003-97154

(51) Int. Cl. H04L 9/00

(52) U.S. Cl. 380/277

(57) ABSTRACT

Provided is a method of transmitting and receiving a message using an encryption/decryption key, by which each of a sender and a recipient can generate an encryption/decryption key and recover a key used for encryption/decryption while transmitting and receiving the message using an electronic device. The method includes: (a) a user generating his/her own private key and a public key, registering the public key with a key recovery agent (KRA), and setting shared secret information; and (b) a sender transmitting the recovery information necessary for decryption of the transmission message to a recipient, and the recipient generating a key necessary for the decryption from the recovery information and decrypting the transmission message. The method may further include the recipient requesting recovery of the session key to the KRA.

This application claims the priority of Korean Patent Application No. 2003-97154, filed on Dec. 26, 2003, in the Korean Intellectual Property Office, the disclosure of which is incorporated herein in its entirety by reference.

### BACKGROUND OF THE INVENTION

1. Field of the Invention

The present invention relates to a method of transmitting and receiving a message using an encryption/decryption key, and more particularly, to a method of transmitting and receiving a message using an encryption/decryption key, by which each of a sender and a recipient can generate an encryption/decryption key and recover a key used for encryption/decryption while transmitting and receiving the message using electronic means.

2. Description of the Related Art

When users transmit messages to each other via electronic means, for example, via the Internet, many things can be electronically realized by guaranteeing confidentiality and integrity of information and providing an authentication function using encryption. Accordingly, encryption is necessary in allowing users to use the convenience and advantages of the Internet.

Confidentiality is achieved by encryption, which guarantees that only an authorized user, i.e., a user with a key, can access specific information. In terms of communication, communication using a cipher between a sender and a recipient (hereinafter, encrypted communication) can be performed if the sender, which encrypts and transmits a message, and the recipient, which receives and decrypts the encrypted message, share the same session key. In general, in a case of encrypting and communicating the message using the electronic means, a symmetric key encryption system, in which the sender and the recipient have the same session key, is used. Therefore, a procedure for sharing the session key between users intending to perform the encrypted communication, i.e., a session key distribution procedure is generally performed before the encrypted communication is performed.

Although there are advantages in using the cipher, when encryption technology is circumvented by criminals, social security can be threatened, and when the session key used for encrypting a message is damaged or lost, even an authorized user of the encrypted message, i.e., a ciphertext, cannot decrypt the ciphertext. To resolve the problem, a key recovery function is used.

The key recovery function is defined in general as a technology or a system that grants decryption ability to only allowed people or agents only if a specific condition is satisfied for encrypted data, in which only a ciphertext owner can decrypt a ciphertext into a plaintext. A key recovery method can be generally divided into a key escrow method and a key capsulation method.

The key escrow method is a method of entrusting a user encryption key, a fragment of the encryption key, or information related to the encryption key to be recovered, to one or more reliable organizations (key recovery agents) and obtaining a plaintext corresponding to the encryption key or a ciphertext from the key information that the one or more agents are keeping in response to an authorized key recovery request. The key escrow method guarantees reliable key recovery but may excessively invade the privacy of general users.

In the key capsulation method, the user encryption key, the fragment of the encryption key, or the information related to the encryption key to be recovered, is included in an encrypted zone, which only the key recovery agent of the user can decrypt, and only the key recovery agent recovers the key from the encrypted zone attached to the ciphertext. The key capsulation method has good characteristics to protect the privacy of general users. However, in the key capsulation method, users can perform the encrypted communication by avoiding the key recovery function.

### SUMMARY OF THE INVENTION

The present invention provides a method of transmitting and receiving a message using an encryption/decryption key, in which a recipient can generate the key to be used for decryption of a ciphertext while encrypted communication is being performed.

The present invention also provides a method of transmitting and receiving a message using an encryption/decryption key, in which the key used for encryption can be correctly recovered in a time of emergency in a variety of environments.

The present invention also provides a method of transmitting and receiving a message using an encryption/decryption key, in which invasion of privacy of a user is minimized when the key is recovered by law enforcement authorities.

The present invention also provides a method of transmitting and receiving a message using an encryption/decryption key, in which cipher users cannot unjustly avoid a key recovery function.

According to an aspect of the present invention, there is provided a method of transmitting and receiving a message using an encryption/decryption key, the method comprising: a user generating his/her own private key and a public key, registering the public key with a key recovery agent (KRA), and setting shared secret information; and a sender transmitting the recovery information necessary for decryption of the transmission message to a recipient, and the recipient generating a key necessary for the decryption from the recovery information and decrypting the transmission message.

The method may further comprise the recipient requesting recovery of the session key to the KRA.

### BRIEF DESCRIPTION OF THE DRAWINGS

The above and other features and advantages of the present invention will become more apparent by describing in detail exemplary embodiments thereof with reference to the attached drawings in which:

FIG. 1A is a flowchart of an exemplary embodiment of the present invention;

FIG. 1B illustrates subjects performing steps of FIG. 1A and procedures realizing the embodiment of the present invention shown in FIG. 1A using the systematic correlation;

FIG. 2A is a flowchart of detailed procedures used to realize a user registration step;

FIG. 2B illustrates the detailed procedures used to realize the user registration step using the systematic correlation;

FIG. 3A is a flowchart of detailed procedures used to realize an encrypted communication step;

FIG. 3B illustrates the detailed procedures used to realize the encrypted communication step using the systematic correlation;

FIG. 4A is a flowchart of detailed procedures used to realize a key recovery request step; and

FIG. 4B illustrates the detailed procedures used to realize the key recovery request step using the systematic correlation.

### DETAILED DESCRIPTION OF THE INVENTION

Hereinafter, the present invention will now be described more fully with reference to the accompanying drawings, in which exemplary embodiments of the invention are shown. Like reference numbers are used to refer to like elements throughout the drawings.

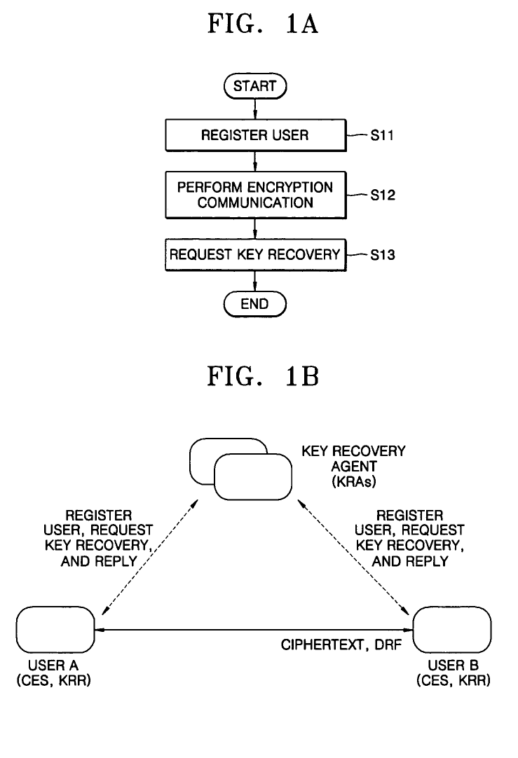

The operation of the present invention is largely divided into a user registration step and an encrypted communication step, and a key recovery request step can be further included in the operation. A flowchart of the present invention is shown in FIG. 1A.

In the user registration step S11, users generate their own private keys and public keys and register the public keys with a key recovery agent (KRA), and at this time, information required between the users and the KRA is set so that the KRA can recover the keys of the users when the users request the KRA to recover the keys.

In the encrypted communication step S12, a sender generates a ciphertext and key recovery information and transmits the ciphertext and the key recovery information to a recipient, and the recipient decrypts the ciphertext transmitted by the sender using a key obtained from the key recovery information and obtains a plaintext.

In the key recovery request step S13, if the user requests the key recovery with a specific condition, key recovery is performed according to the specific condition. To do this, a key recovery requestor must have the ciphertext and the key recovery information corresponding to the ciphertext, and the ciphertext and the key recovery information can be obtained by methods such as a legal listening-in method.

Subjects related to realizing each of the steps are as follows, and FIG. 1B illustrates the subjects and procedures realizing the embodiment of the present invention shown in FIG. 1A using the systematic correlation.

Cryptographic end system (CES): A CES is an encrypted communication terminal that encrypts and decrypts data and can be realized with hardware or software. A sender generates a data recovery field (DRF) and transmits the DRF attached to a ciphertext to a recipient, and the recipient decrypts the ciphertext using the DRF and checks the validity of the DRF according to necessity. In FIG. 1B, a user A and a user B are the CESs.

Key recovery agent (KRA): A KRA safely keeps the information necessary for recovering keys, and performs key recovery in response to an authorized key recovery request of a key recovery requestor or supplies the information necessary for recovering keys. More than one KRA can exist.

Key recovery requestor (KRR): A KRR is an authorized individual having a right to request a KRA to recover encrypted data according to law enforcement or user's necessity. The KRR can be an individual user, law enforcement authorities, or an organization which a user belongs to (for example, a company).

Symbols used in the present invention are as follows.
P: a large prime number equal to 2q+1 where q is a very large prime number
g: a generator of Z*ₚ

Here, Z*ₚ is a set of total elements, which are coprime with P, among elements of Zₚ={0, 1, . . . , P−1}, and when P is a prime number, Z*ₚ={1, 2, . . . , P−1}. The generator g generates numbers so that powers of all elements of Z*ₚ constitute Z*ₚ using mod P. That is, g¹ mod p, g² mod P, . . . , g^{P-1} mod P are numbers constituting all elements of Z*ₚ. In cryptology, Z*ₚ and the generator g are symbols typically used.
X_{A}: a private key of a user A
Y_{A}: a public key of user A
KT_{Ai}: a secret value, which an ith KRA of user A selects and keeps, (i is an integer more than 1)
h( ): a certain one-way hash function
E( ): a certain encryption algorithm
D( ): a decryption algorithm corresponding to E( )
Sig( ): a certain electronic signature algorithm

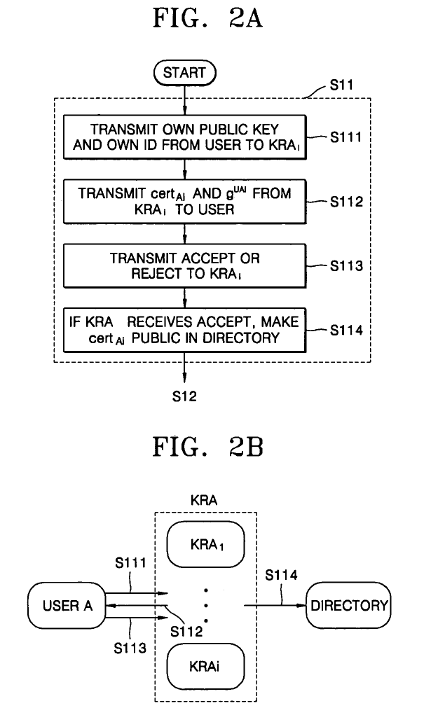

FIG. 2A is a flowchart of detailed procedures used to realize a user registration step. FIG. 2B illustrates the detailed procedures used to realize the user registration step using the systematic correlation.

As described above, in the user registration step S11 each of a number of users generates his or her own private key and a public key and registers the public key with a KRA belonging to his or her own territory, that is, sets secret information shared between user And the KRA.

The users can select more than one proper KRA, wherein the number of KRAs depends on the policy of each organization (law enforcement authorities or company). In the present invention, it is assumed that the users use 2 KRAs (KRA₁ and KRA₂), user A plays a role of a sender, and user B plays a role of a recipient. Also, it is assumed that equations used hereinafter are congruence expression operations performed on mod P.

In step S11, user A generates the own private key and public key pair (X_{A}, Y_{A}) and transmits the public key and an own identifier ID_{A} to KRA₁ or KRA₂ (hereinafter, KRAᵢ) which user A selects.

KRAᵢ, which has received the public key Y_{A} and ID_{A} of user A, randomly selects KT_{Ai}, calculates U_{Ai}=h(KT_{Ai}, ID_{A}), Aᵢ=Y_{A}^{UAi}, v_{Ai}=g^{Ai}, and cert_{Ai}=Sig(Y_{A}, v_{Ai}), transmits cert_{Ai} and g^{UAi} to user A in step 112, and stores ID_{A} and KT_{Ai}.

That is, KRAᵢ generates U_{Ai}, which is a hash value of KT_{Ai} and ID_{A}, Aᵢ, which is a power value of U_{Ai} for the public key Y_{A} of user A, v_{Ai}, which is a power value of Aᵢ for the generator g, and a certificate cert_{Ai}, which is a signature for Y_{A} and v_{Ai}. KRAᵢ transmits cert_{Ai} and g^{UAi} to user A in step 112 and stores ID_{A} and KT_{Ai}. Each of the users can generate information shared among the users from his or her own secret information and public information using the above information.

User A calculates v_{Ai} as follows, extracts v_{Ai} from cert_{Ai}, and determines validity of the information received from KRAᵢ by checking whether the two values are the same.

In step S113, if the two values are the same, user A processes the information received from KRAᵢ and transmits to KRAᵢ “Accept” or “Reject” according to whether a protocol is continuously performed or finished.
Aᵢ=(g^{UAi})^{XA}
v_{Ai}=g^{Ai}

In step S114, if KRAᵢ receives “Accept” from user A, KRAᵢ makes cert_{Ai} public in a directory, and if KRAᵢ receives “Reject” from user A, KRAᵢ finishes the communication process. In a public key based structure, in general, the public key and the certificate are disclosed in a public directory, which everybody can access, and the directory also means the public directory.

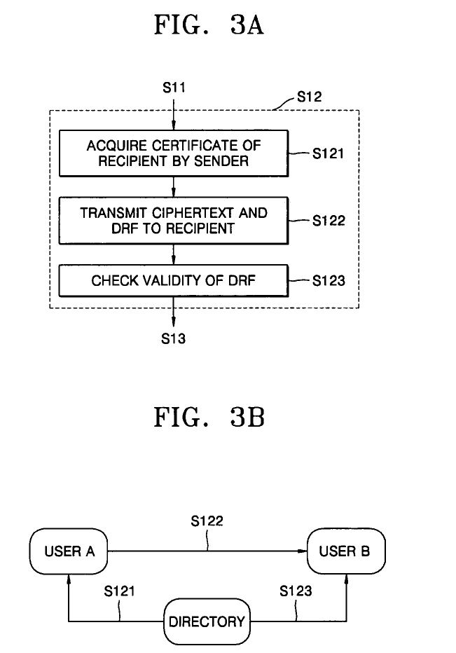

FIG. 3A is a flowchart of detailed procedures used to realize an encrypted communication step. FIG. 3B illustrates the detailed procedures used to realize the encrypted communication step using the systematic correlation.

After user registration is performed, encrypted communication between the registered users A and B can be performed. In a conventional method, users A and B intending to perform the encrypted communication must beforehand share a session key K to be used for encrypting and decrypting a message in a conventional method.

In the present specification, a conventional system, in which the registered users A and B have shared the session key K in advance, is described, and the encrypted communication and key recovery, in which key pre-distribution that is one of features of the present invention is unnecessary, are described after a conventional encrypted communication procedure is described.

In the conventional encrypted communication procedure, to transmit and receive a message between users A and B, users A and B must share the session key K necessary for encrypting and decrypting the message in advance. That is, the session key K must be pre-distributed to both of the sender and the recipient.

User A acquires a certificate of user B from a directory in step S121. User A calculates ωᵢ=v_{Bi}^{Ai} from his or her own secret information Aᵢ and public information v_{Bi} included in the certificate of user B (after this, user B can calculate the same from his or her own secret information Bᵢ and public information v_{Ai} included in the certificate of user A and a session key based on ωᵢ). User A randomly selects a session identifier (SID), calculates KEKᵢ=h(ωᵢ,SID) which is a fragment of a key encryption key (KEK) used for encrypting the session key K, and obtains the KEK by performing an exclusive-OR operation on the calculated KEKᵢs (KEK=KEK₁<XOR>KEK₂). User A generates a ciphertext C (C=E_{K}(M)), with which a transmission message M is encrypted, and a data recovery field (DRF), which is information necessary for user B to recover the session key K. The DRF is obtained as follows.
DRF=ESK∥SID∥cert_{A1}, ∥cert_{A2}∥cert_{B1}∥cert_{B2}

That is, DRF is obtained by merging 6 values: ESK, SID, cert_{A1}, cert_{A2}, cert_{B1}, and cert_{B2}.

User A transmits the generated ciphertext C and the generated DRF to user B in step S122. User B, which has received the ciphertext C and the DRF, decrypts the ciphertext C using the pre-distributed session key K and obtains the message M, i.e., a plaintext (M=D_{K}(C)).

Before user B decrypts the ciphertext C, user B can check validity of the DRF received from user A to confirm that the session key K can be recovered by the KRA.

To check validity of the DRF, user B acquires the certificate of user A from the directory in step S123. User B calculates ωᵢ=v_{Ai}^{Bi} from his or her own secret information Bᵢ and the public information v_{Ai} obtained from the certificate of user A, obtains the KEK by calculating KEKᵢ=h(ωᵢ,SID) which is a fragment of the KEK from ωᵢ=v_{Ai}^{Bi}, and obtains the ESK (ESK=E_{KEK}(K)). User B checks the validity of the DRF by confirming the ESK obtained by user B and the ESK included in the DRF received from user A are the same. If the DRF does not pass the validity check, a CES 31 of user B can reject decryption of the ciphertext, and the decryption of the ciphertext is determined according to a policy.

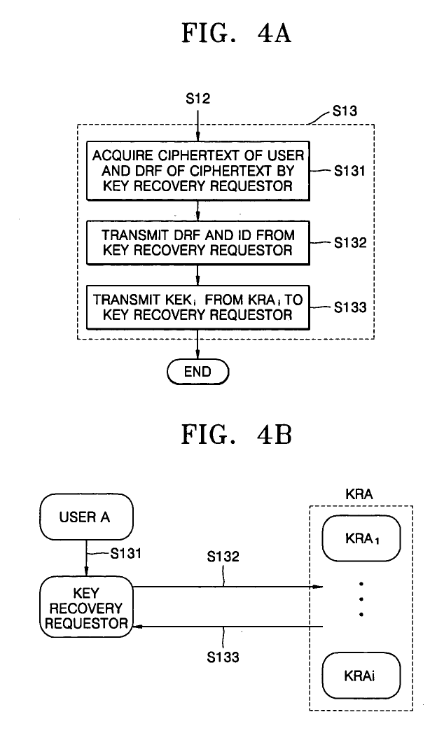

FIG. 4A is a flowchart of detailed procedures used to realize a key recovery request step. FIG. 4B illustrates the detailed procedures used to realize the key recovery request step using the systematic correlation.

The present invention can comprise only steps S11 and S12. However, a user (a key recovery requestor) can ask a key recovery agent to recover a key when key recovery is necessary as described above. The key recovery requestor can be law enforcement authorities, an entrepreneur, or a ciphertext owner. To be able to recover a recovery requested key, the key recovery requestor must acquire the ciphertext C and the DRF of the ciphertext C from user A in step S131.

The key recovery requestor requests KRAᵢ to recover the key by transmitting a DRF and an ID_{A} of the ciphertext to be decrypted to KRAᵢ and in step S132.

KRAᵢ, which has received the key recovery request, calculates KEKᵢ, which is a fragment of the KEK, using KT_{Ai} corresponding to the ID_{A}, the public key Y_{A} Of user A, and v_{Bi} obtained from the certificate of user B and transmits KEKᵢ to the key recovery requestor in step S133.

The key recovery requestor obtains the KEK (KEK=KEK₁<XOR>KEK₂) using KEKᵢ received from KRAᵢ decrypts the ESK in the DRF using the KEK, and acquires the session key K (K=D_{KEK}(ESK)).

As already described, according to the present invention, the session key K does not have to be pre-distributed to both of the sender and the recipient, and the session key K is generated in the sender and the recipient during the encrypted communication. This is achieved by using the KEK as the session key K by user A in the encrypted communication step S12.

That is, after user A obtains the KEK by performing an exclusive-OR operation on KEKᵢs, user A directly designates the KEK as the session key K (KEK=KEK₁<XOR>KEK₂ and K=KEK) without obtaining the ESK, in which the session key K is decrypted, which is different from a conventional method.

Also, the DRF is obtained by removing the ESK from the conventional method (DRF=SID∥cert_{A1}∥cert_{A2}∥cert_{B1}∥cert_{B2}).

User B, the recipient, can decrypt the ciphertext C by directly calculating and generating the session key with a method of obtaining the KEK using the DRF validity check process described above. At this time, if user A transmits an unauthorized DRF to circumvent the key recovery by the KRA, since user B also cannot recover a right session key, a normal encrypted communication cannot be performed. Accordingly, circumvention of the key recovery is prevented.

The present invention can perform an efficient encrypted communication by distributing an encryption/decryption key during an encrypted communication process. Accordingly, efficiency of communication increases, and simultaneously, circumvention of the key recovery by an unauthorized user is prevented.

Also, since the present invention recovers a session key using information based on the session when the key recovery is performed, privacy of a user is well protected, and flexibility that the user selects a key recovery agent at will is provided.

The present invention may be embodied in a general-purpose computer by running a program from a computer readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present invention may be embodied as a computer readable medium having a computer readable program code unit embodied therein for causing a number of computer systems connected via a network to effect distributed processing.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of transmitting and receiving a message using an encryption/decryption key, the method comprising:
(a) a user generating a private key and a public key, registering the public key with a key recovery agent (KRA), and setting shared secret information; and
(b) a sender transmitting the recovery information necessary for decryption of the transmission message to a recipient, and the recipient generating a key necessary for the decryption from the recovery information and decrypting the transmission message.

2. The method of claim 1, further comprising:
(c) requesting recovery of the session key from the recipient to the KRA.

3. The method of claim 1, wherein step (a) comprises:
(a1) the user generating the private key and the public key and transmitting the public key and an identifier to the KRA;
(a2) randomly selecting KT_{Ai} in the KRA, calculating U_{Ai}=h(KT_{Ai}, ID_{A}), Aᵢ=Y_{A}^{UAi}, v_{Ai}=g^{Ai}, and cert_{Ai}=Sig(Y_{A}, v_{Ai}) in the KRA, and transmitting cert_{Ai} and g^{UAi} from the KRA to the user;
(a3) determining validity of the information received from the KRA by directly calculating v_{Ai} from the user's known information, extracting v_{Ai} from cert_{Ai}, and checking whether the two values are the same by the user, and transmitting “Accept” or “Reject” from the user to the KRA according to the validity determination result; and
(a4) if the KRA receives “Accept,” making cert_{Ai} public in a directory, and if the KRA receives “Reject,” finishing the protocol.

4. The method of claim 1, wherein step (b) comprises:
(b1) acquiring a certificate of the recipient by the sender; and
(b2) generating and transmitting a ciphertext, with which the sender has encrypted the transmission message, and a data recovery field (DRF) which is information necessary for the recipient to recover the session key K.

5. The method of claim 4, further comprising (b3) before the recipient decrypts the ciphertext C, checking validity of the DRF received from the sender in the KRA to confirm that the session key K can be recovered.

6. The method of claim 2, wherein step (c) comprises:
(c1) acquiring a ciphertext of the transmission message and the DRF of the ciphertext from the sender to be able to recover the recovery requested session key in the recipient;
(c2) transmitting a DRF and an ID_{A} of the ciphertext to be decrypted from the recipient to the KRA and requesting the key recovery by the recipient; and
(c3) calculating KEKᵢ, which is a fragment of the KEK, using KT_{Ai} corresponding to the ID_{A}, the public key of the sender, and v_{Bi} obtained from the certificate of the recipient in the KRA and transmitting KEKᵢ from the KRA to the recipient.

7. A computer readable medium having recorded thereon a computer readable program for performing the method of claim 1
